(19) United States
(12) Patent Application Publication
(10) Pub. No.: US 2005/0076763 A1
(43) Pub. Date: Apr. 14, 2005

(54) Guitar baffle system

(76) Inventor: Henry E. Langeman, Wenatchee, WA (US)

Correspondence Address: Michael S. Neustel;Suite No. 4, 2534 South University Drive, Fargo, ND, 58103, US

(21) Appl. No.: 10/686,839

(22) Filed: Oct. 14, 2003

(51) Int. Cl. G10D 3/00

(52) U.S. Cl. 84/290

(57) ABSTRACT

A guitar baffle system for increasing the volume of sound generated by a guitar. The guitar baffle system includes a baffle centrally positioned within the guitar body. The baffle has a first end and a second end that are distally spaced from the sidewall of the guitar body thereby forming a first opening and a second opening respectively between thereof. The baffle is substantially parallel to a soundboard of the guitar body. The baffle delays the sound amplified from the interior of the guitar body.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to acoustic guitars and more specifically it relates to a guitar baffle system for increasing the volume of sound generated by a guitar.

2. Description of the Related Art

Non-amplified guitars (e.g. acoustic guitars) have been in use for years. FIG. 1 illustrates a conventional acoustic guitar comprised of a hollow guitar body (20) with a sound hole (22) within a soundboard (28) wherein the soundboard is opposite of a back wall (24), an elongate neck (23) extending from the guitar body, a bridge (21) attached to the soundboard, and a plurality of guitar strings (25) attached between a distal portion of the neck and to the bridge. When the strings vibrate, the vibrations travel through the bridge to the soundboard thereby vibrating the soundboard. The body of the guitar forms a hollow sound box that amplifies the vibrations of the soundboard. The amplified sound travels through the sound hole within the soundboard.

While these devices may be suitable for the particular purpose to which they address, they are not as suitable for increasing the volume of sound generated by a guitar.

### BRIEF SUMMARY OF THE INVENTION

In view of the foregoing disadvantages inherent in the known types of acoustic guitars now present in the prior art, the present invention provides a new guitar baffle system construction wherein the same can be utilized for increasing the volume of sound generated by a guitar.

The general purpose of the present invention, which will be described subsequently in greater detail, is to provide a new guitar baffle system that has many of the advantages of the acoustic guitars mentioned heretofore and many novel features that result in a new guitar baffle system which is not anticipated, rendered obvious, suggested, or even implied by any of the prior art acoustic guitars, either alone or in any combination thereof.

To attain this, the present invention generally comprises a baffle centrally positioned within the guitar body. The baffle has a first end and a second end that are distally spaced from the sidewall of the guitar body thereby forming a first opening and a second opening respectively between thereof. The baffle is substantially parallel to a soundboard of the guitar body. The baffle delays the sound amplified from the interior of the guitar body.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a guitar baffle system that will overcome the shortcomings of the prior art devices.

A second object is to provide a guitar baffle system for increasing the volume of sound generated by a guitar.

Another object is to provide a guitar baffle system that may be utilized within various types of acoustic guitars.

An additional object is to provide a guitar baffle system that is comprised of a simple design.

A further object is to provide a guitar baffle system that has more sustain than a conventional guitar.

Another object is to provide a guitar baffle system that delays the sound combing from the backside of the guitar body.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of a conventional acoustic guitar.

FIG. 2 is an upper perspective view of the present invention.

FIG. 3 is an upper perspective view of a soundboard removed from the guitar body.

FIG. 4 is an upper perspective view of a back wall removed from the guitar body.

FIG. 5 is a front view of the present invention positioned within a guitar body.

FIG. 6 is a rear view of the present invention positioned within a guitar body.

FIG. 7 is a cross sectional view taken along line 7-7 of FIG. 5.

FIG. 8 is a cross sectional view taken along line 8-8 of FIG. 5.

### DETAILED DESCRIPTION OF THE INVENTION

A. Overview

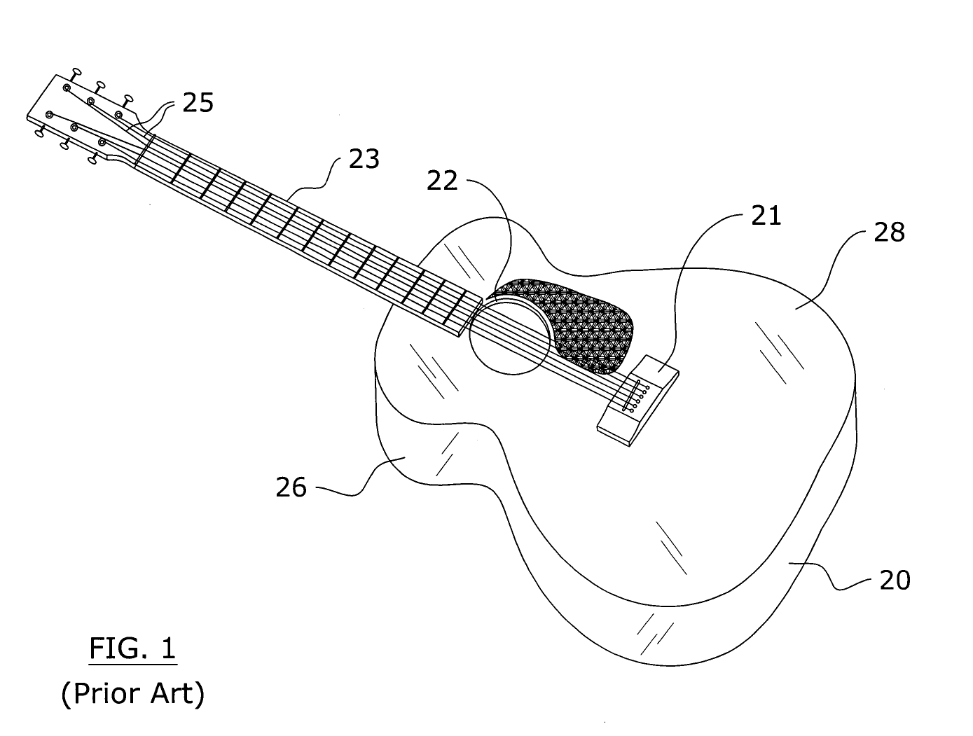

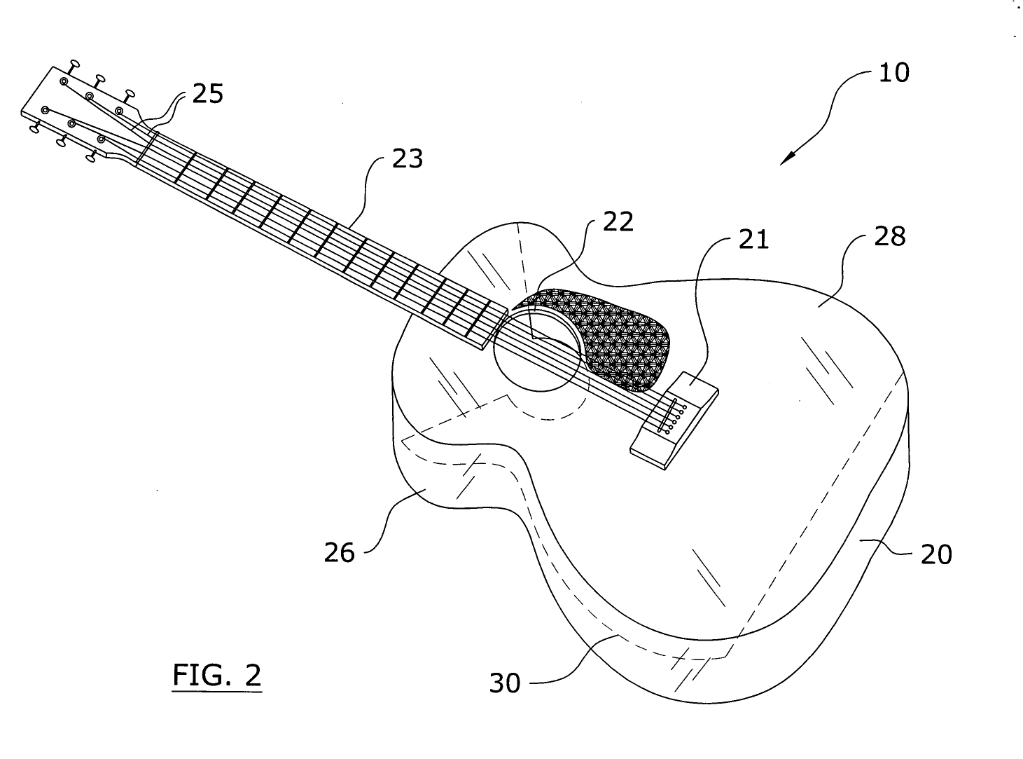

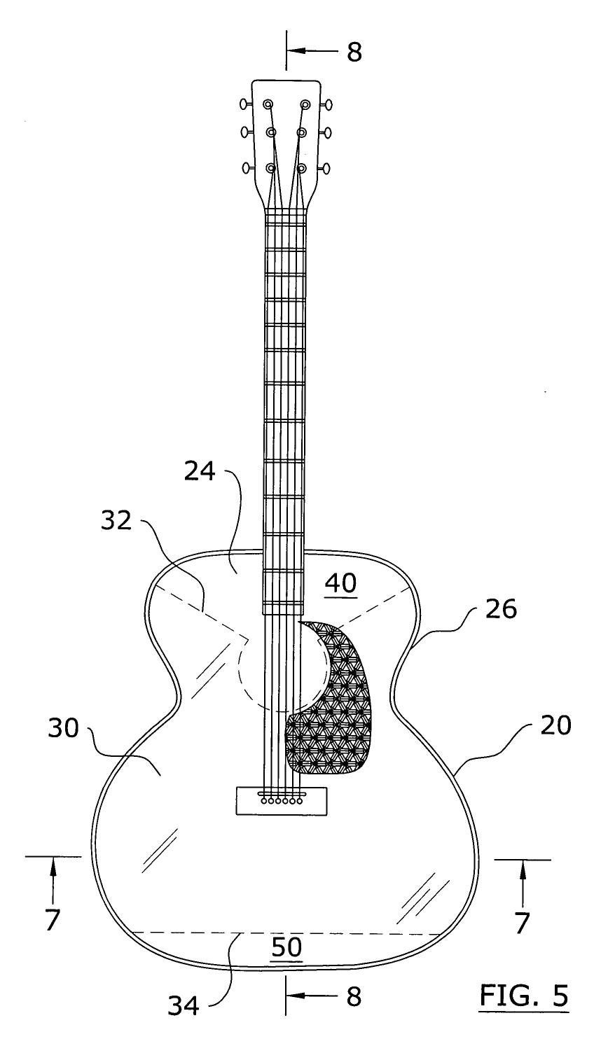

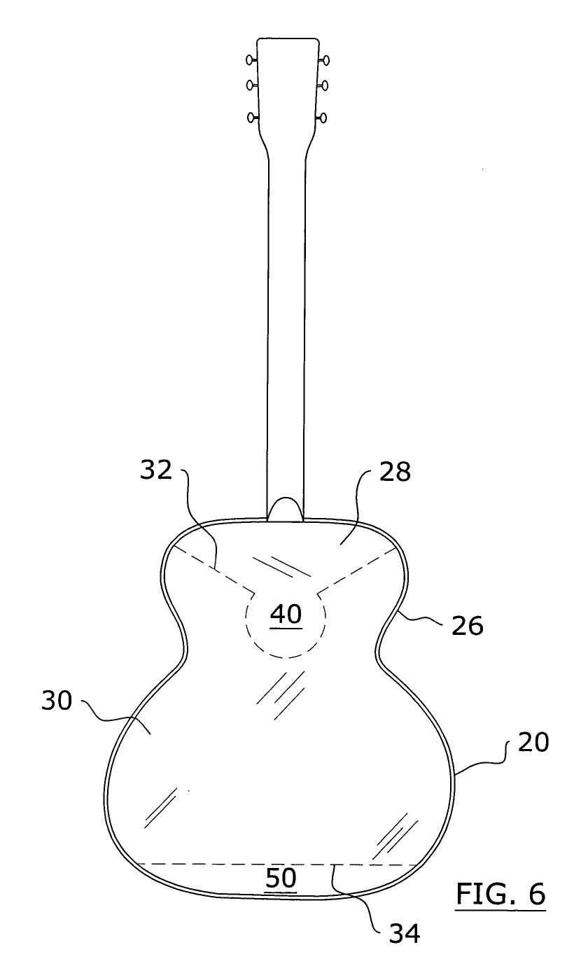

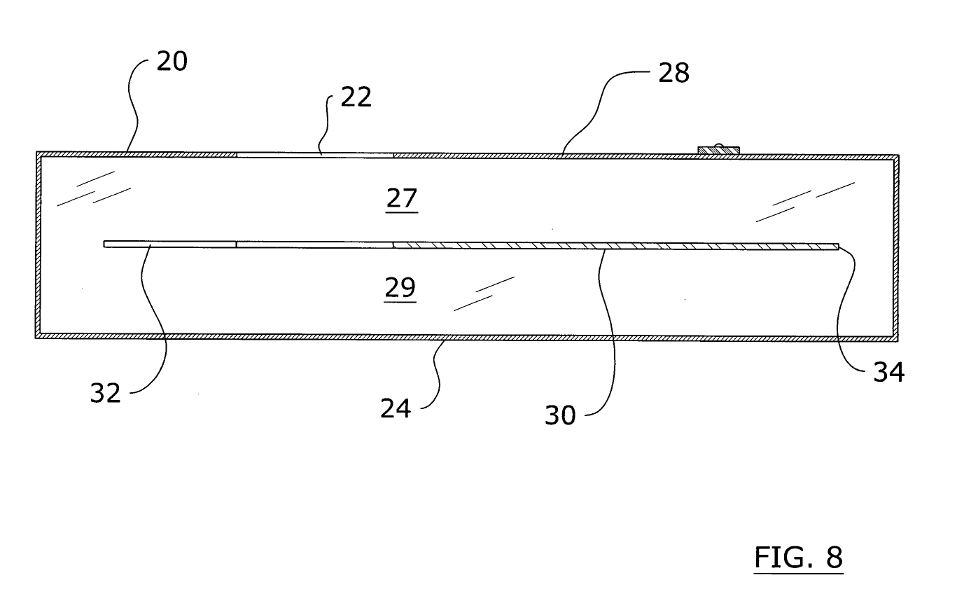

Turning now descriptively to the drawings, in which similar reference characters denote similar elements throughout the several views, FIGS. 1 through 8 illustrate a guitar baffle sytem 10, which comprises a baffle 30 centrally positioned within the guitar body 20. The baffle 30 has a first end 32 and a second end 34 that are distally spaced from the sidewall 26 of the guitar body 20 thereby forming a first opening 40 and a second opening 50 respectively between thereof. The baffle 30 is substantially parallel to a soundboard 28 of the guitar body 20. The baffle 30 delays the sound amplified from the interior of the guitar body 20.

B. Guitar Body

The present invention may be utilized in various types of guitar bodies and structures. FIGS. 1 through 8 illustrate an exemplary guitar body 20, however various other types of guitar bodies may be utilized within the present invention.

The guitar body 20 has an interior cavity that assists in amplifying the sound. The guitar body 20 typically comprises a soundboard 28 having a sound hole 22, at least one sidewall 26 attached to the soundboard 28, a bridge 21 attached to the sound board, a back wall 24 attached to the sidewall 26 opposite of the soundboard 28, and a neck 23 extending from the guitar body 20 as illustrated in FIGS. 1 through 8 of the drawings. Various other conventional acoustic and non-acoustic guitar components may be attached to the guitar body 20 as can be appreciated.

C. Baffle

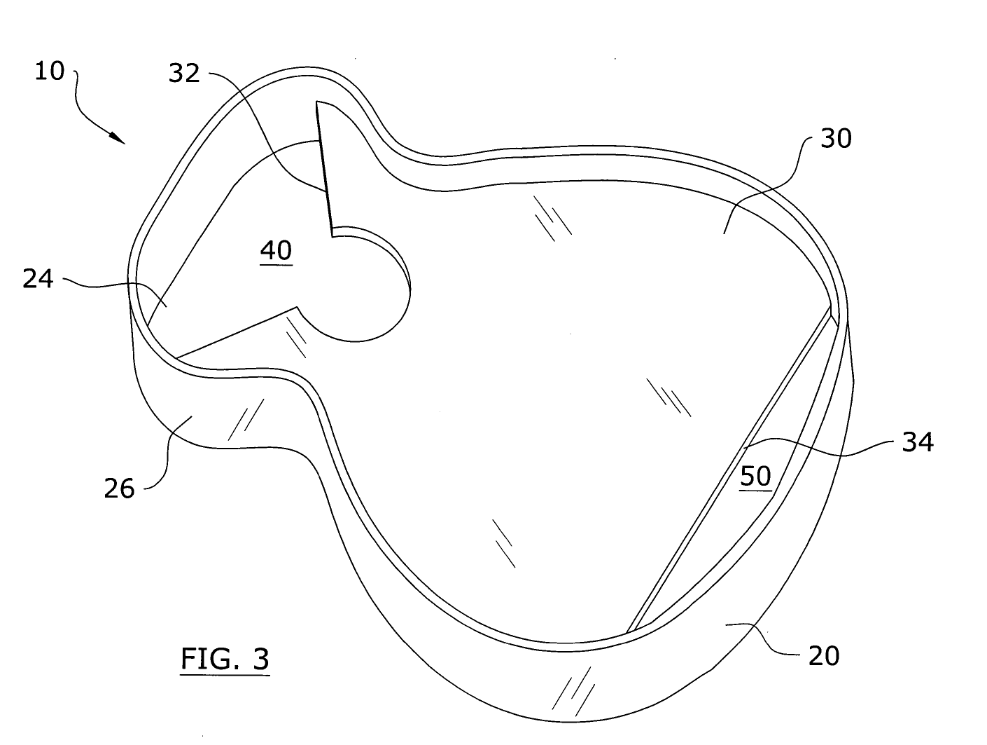

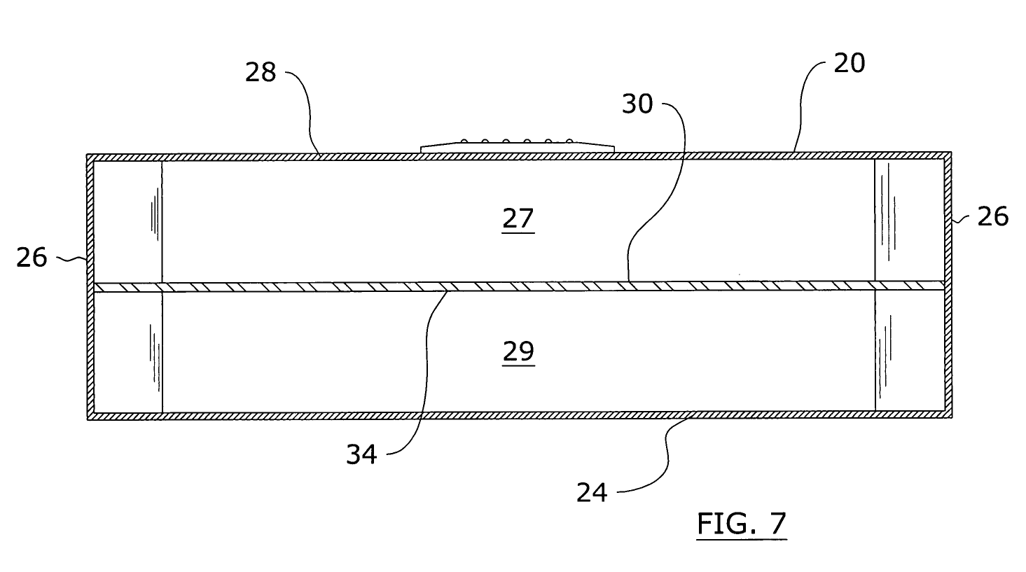

The baffle 30 attached to the sidewall 26 within the interior cavity of the guitar body 20 substantially parallel to the soundboard 28. As shown in FIG. 7 of the drawings, the baffle 30 is attached to opposing interior surfaces of the sidewall 26. The baffle 30 separates the interior cavity of the guitar body 20 into an upper cavity 27 and a lower cavity 29. The baffle 30 may have a flat and straight structure as illustrated in FIGS. 3, 4, 7 and 8 of the drawings.

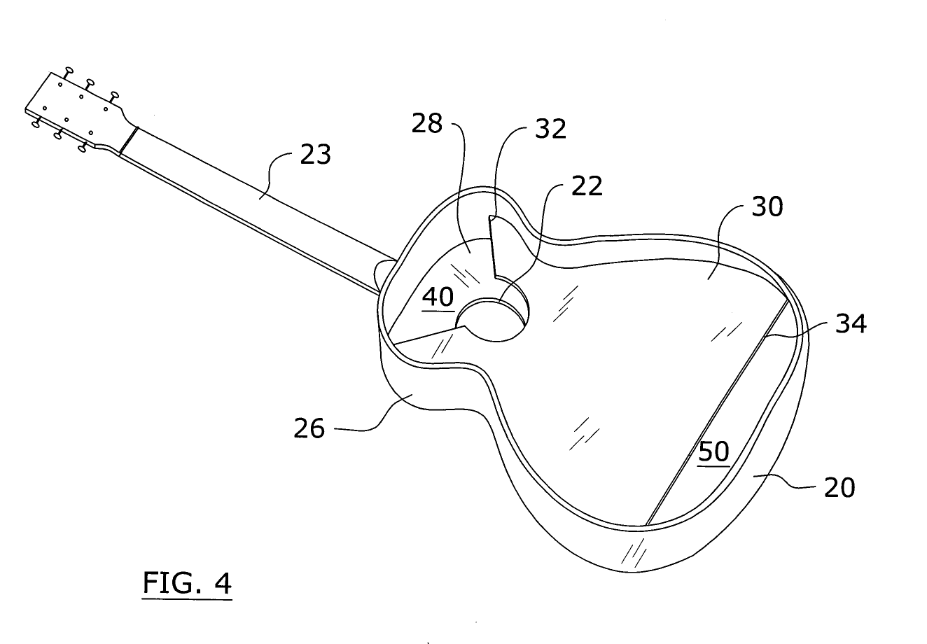

The baffle 30 may be positioned centrally between the back wall 24 and the soundboard 28 as illustrated in FIGS. 3, 4, 7 and 8 of the drawings. A first opening 40 is between the sidewall 26 and a first end 32 of the baffle 30 as shown in FIGS. 3 and 4 of the drawings.

A second opening 50 is between the sidewall 26 and a second end 34 of the baffle 30 as further shown in FIGS. 3 and 4 of the drawings. The first opening 40 and the second opening 50 fluidly connect the upper cavity 27 and the lower cavity 29 to allow sound waves to travel between thereof.

The second end 34 of the baffle 30 may be straight as shown in FIGS. 3 and 4 of the drawings. The second end 34 may be substantially transverse with respect to a longitudinal axis of the guitar body 20 as further shown in FIGS. 3 and 4 of the drawings. The second end 34 of the baffle 30 is positioned near an end of the guitar body 20 opposite of the neck 23 as shown in FIG. 4 of the drawings.

The first end 32 of the baffle 30 has a center cutout corresponding to the sound hole 22 as shown in FIG. 4 of the drawings. The first end 32 of the baffle 30 has two opposing slanted side portions as shown in FIGS. 3 and 4 of the drawings.

D. Operation of Invention

In use, when the strings 25 of the guitar are struck by a user, the vibrations of the strings 25 are transferred to the bridge 21 and then to the soundboard 28. The soundboard 28 vibrates accordingly and generates sound waves within the interior cavity of the guitar body 20. The baffle 30 also vibrates according to the sound waves and assists in amplifying the sound before being emitted through the sound hole 22. The baffle 30 also delays the sound reflected from the back wall 24 and the lower cavity 29 thereby creating a sustained sound from the guitar. In addition, the first opening 40 and the second opening 50 act as dual air columns reinforcing each other as the baffle 30 vibrates according to the sound waves.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A guitar baffle system, comprising:
a guitar body having an interior cavity, said guitar body comprising a soundboard having a sound hole, at least one sidewall attached to said soundboard, a back wall attached to said sidewall opposite of said soundboard, and a neck extending from said guitar body; and
a baffle attached to said sidewall within said interior cavity substantially parallel to said soundboard, wherein said baffle separates an upper cavity and a lower cavity within said guitar body;
a first opening between said sidewall and a first end of said baffle; and
a second opening between said sidewall and a second end of said baffle, wherein said first opening and said second opening fluidly connect said upper cavity and said lower cavity.

2. The guitar baffle system of claim 1, wherein said baffle is comprised of a flat structure.

3. The guitar baffle system of claim 2, wherein said baffle is comprised of a straight structure.

4. The guitar baffle system of claim 1, wherein said baffle is positioned centrally between said back wall and said soundboard.

5. The guitar baffle system of claim 1, wherein said baffle is attached to opposing interior surfaces of said sidewall.

6. The guitar baffle system of claim 1, wherein said second end of said baffle is straight.

7. The guitar baffle system of claim 6, wherein said second end is substantially transverse with respect to a longitudinal axis of said guitar body.

8. The guitar baffle system of claim 1, wherein said first end of said baffle has a center cutout corresponding to said sound hole.

9. The guitar baffle system of claim 8, wherein said first end of said baffle has two opposing slanted side portions.

10. The guitar baffle system of claim 1, wherein said second end of said baffle is positioned near an end of said guitar body opposite of said neck.

11. A guitar baffle system, comprising:
a guitar body having an interior cavity, said guitar body comprising a soundboard having a sound hole, at least one sidewall attached to said soundboard, a back wall attached to said sidewall opposite of said soundboard, and a neck extending from said guitar body;
a baffle having a flat and straight structure attached to said sidewall within said interior cavity substantially parallel to said soundboard, wherein said baffle is positioned centrally between said back wall and said soundboard and wherein said baffle separates an upper cavity and a lower cavity within said guitar body;
a first opening between said sidewall and a first end of said baffle;
a second opening between said sidewall and a second end of said baffle, wherein said first opening and said second opening fluidly connect said upper cavity and said lower cavity;
wherein said baffle is attached to opposing interior surfaces of said sidewall;
wherein said second end of said baffle is straight;
wherein said second end is substantially transverse with respect to a longitudinal axis of said guitar body;
wherein said first end of said baffle has a center cutout corresponding to said sound hole and wherein said first end of said baffle has two opposing slanted side portions; and
wherein said second end of said baffle is positioned near an end of said guitar body opposite of said neck.
